(19) United States
(12) Patent Application Publication
(10) Pub. No.: US 2007/0199229 A1
(43) Pub. Date: Aug. 30, 2007

(54) Worm threader and method of use to create a standing worm

(76) Inventors: Richard Carder JR., Morgantown, WV (US); Edward Mario Mayle, Morgantown, WV (US)

Correspondence Address: William Aylor, 886 Chestnut Ridge Road, Room 211, Morgantown, WV, 26506-6216, US

(21) Appl. No.: 11/361,651

(22) Filed: Feb. 24, 2006

(51) Int. Cl. A01K 97/00

(52) U.S. Cl. 43/4; 43/55

(57) ABSTRACT

A worm threader comprising a pointed threader and a handle having a first end and a second end wherein said first end contains a notch for holding fishing line and said second end is attached to said pointed threader. The method of using the worm threader to create a standing worm comprising attaching a hook to a fishing line, wrapping said fishing line around a worm threader containing a notch in the handle, inserting said worm threader into a worm, threading said worm on a hook so that the hook is not exposed, a means of inflating the worm and adding a sinker an effective length from the worm.

### CROSS-REFEREENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF THE INVENTION

Millions of people enjoy the sport of fishing every year. New fishing lures and methods are developed as fishermen continue to experiment with techniques. Although new lures are in constant development, worms continue to be successful baits for fishing. Worms are less expensive than lures and are oftentimes as successful or more successful if used properly. One of the drawbacks of worms is that fish will often either eat around the hook or spit the hook back out if they feel it in their mouths. One attempt to overcome this obstacle has been the introduction of a worm threader. The worm threader allows the fisherman to bury the hook within the worm. The fish can then not feel the hook and will swallow the worm. The purpose of the method is to create a worm that appears to be standing in the water which gives the appearance of a worm falling through the water to a fish.

There are currently patents on some worm threading devices. However, the use of worm threaders remains difficult as the user must control a hook, the line, a worm, and his pole. The worm threader disclosed has an additional feature of a notch for the fishing line to be wrapped around while the worm is threaded. This creates added stability for the fisherman while threading a worm. When successful, the threaders create a worm that has a hook that is invisible to the fish, however, success in catching has not necessarily increased. One of the reasons is because the worm is either floating on the surface of the water, dangling in the water from a taught fishing line, or sunk to the bottom of the waterbed using a sinker. The standing worm method entices a successful catch by creating a lure that has a worm with no visible hooks and also appears to be falling to the fish.

### BRIEF SUMMARY OF THE INVENTION

According to the invention, a worm threader and accompanying method are used to create a worm that appears to stand to the fisherman and be falling to a fish. The worm threader contains an additional notch in the handle to wrap the fishing line around and create added stability for the user. The resulting product of the use of the threader and the method is a worm with no visible hook and a worm in which the fish cannot see the hook. The worm also appears to be falling through the water as opposed to sitting on top, sitting on the waterbed, or appearing limp in the water in between.

### BRIEF DESCRIPTION OF THE SEVERAL VEIWS OF THE DRAWING

FIG. 1 is a perspective view of a worm threader.

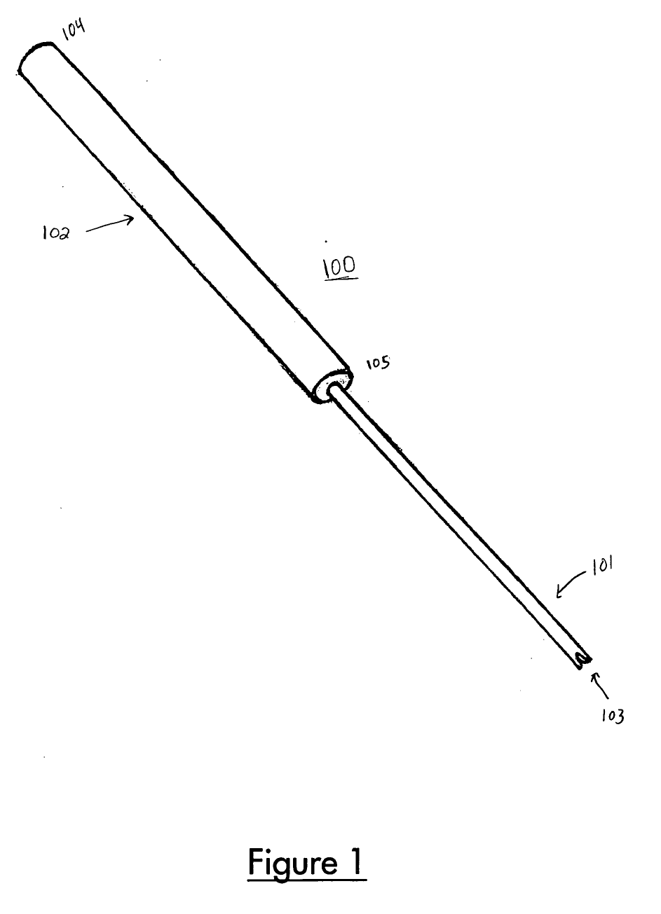

FIG. 2 is a perspective view of the inflation of a worm.

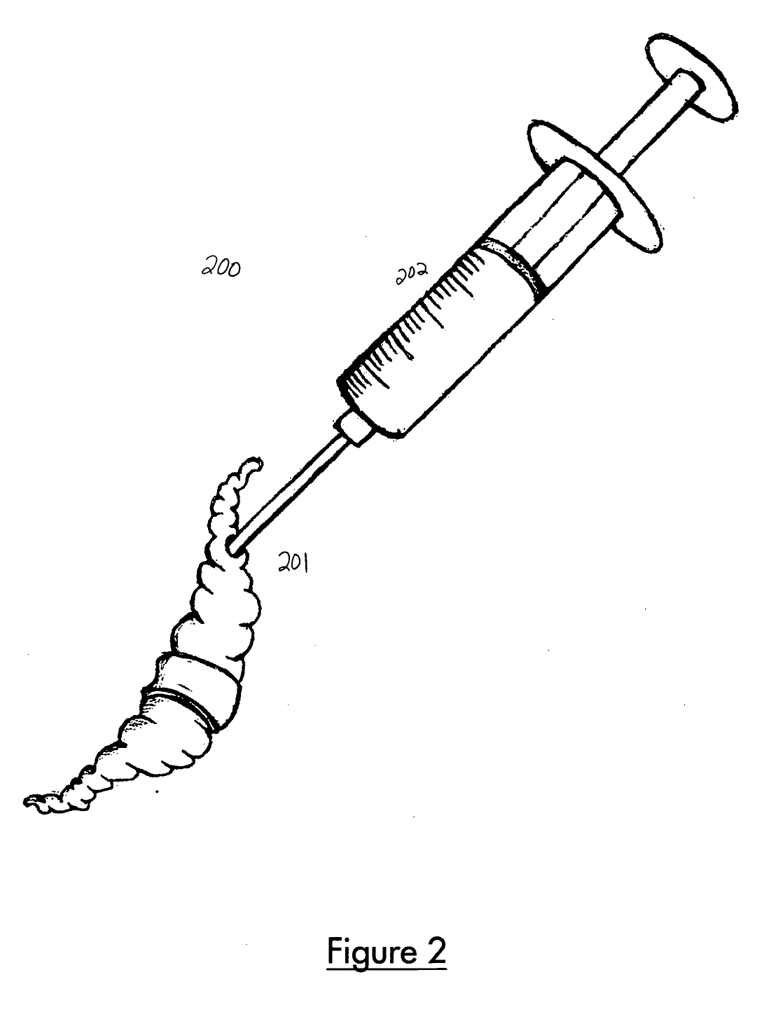

FIG. 3 is a perspective view of the standing worm.

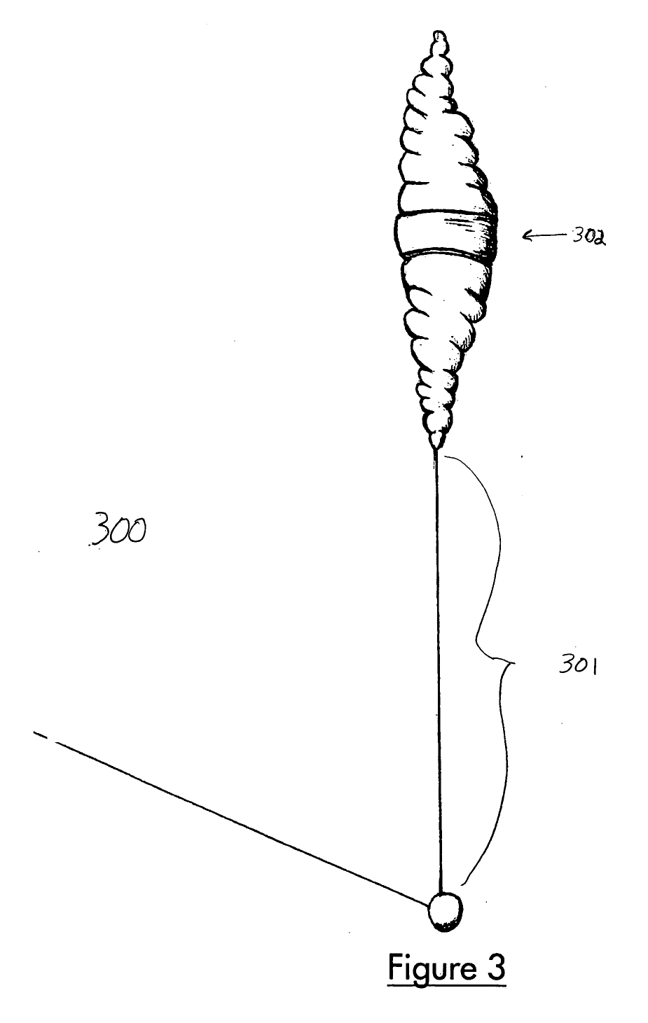

### DETAILED DESCRIPTION OF THE INVENTION

The present invention contemplates an improved worm threader (100) and a method of use of a worm threader to create a standing worm (300). The worm threader comprises a pointed threader (101) wherein said pointed threader contains a notch for the hook (103) and wherein said threader further comprises a handle (102) having a first end (104) and a second end (105) wherein said first end contains a notch for holding fishing line and said second end is attached to said pointed threader. The notch for holding fishing line can be used by the fisherman to add stability to the fishing pole, the line and for the fisherman as the worm threader is used to bury a hook within the worm.

The method for creating a standing worm comprises inserting a worm threader into a worm, threading said worm on a hook so that the hook is not exposed, inflating the worm (200), and adding a sinker an effective length from the worm (301). The worm threader is positioned near the center point of the worm and inserted with a hook so that the hook is totally encapsulated within the worm. The inflation of the worm is carried out by the addition of a gas to the worm (201). Air is the preferred gas, but any gas with a density less than water would work. The preferred means of adding the inflation material is a syringe (202), however, any standard device for adding a gas would perform the function. The sinker is added to the line so that the worm will not float on top of the water. The effective length of the sinker from the worm can be varied depending on many factors including the depth of the water, the type of fish attempting to catch, the depths of the fish, or any other preference. Due to the gas and the sinker, the worm will appear to stand (302) at a height of the difference between the worm and the sinker (301). In an alternative method of use, the present worm threader is utilized to add stability to the creation of a standing worm. This alternative method to create a standing worm comprises attaching a hook to a fishing line, wrapping said fishing line around a worm threader containing a notch in the handle, inserting said worm threader into a worm, threading said worm on a hook so that the hook is not exposed, a means of inflating the worm, and adding a sinker an effective length from the worm.

These terms and specifications serve to describe the invention by example and not to limit the invention. It is expected that others will perceive differences, which, while differing from the forgoing, do not depart from the scope of the invention herein described and claimed.

What is claimed is:

1. A method for creating a standing worm comprising:
inserting a worm threader into a worm;
threading said worm on a hook so that the hook is not exposed;
a means of inflating the worm; and
adding a sinker an effective length from the worm.

2. The method for creating a standing worm from claim 1 wherein said means of inflating the worm is adding air.

3. The method for creating a standing worm from claim 1 wherein said means of inflating the worm is a syringe.

4. The method for creating a standing worm from claim 2 wherein said means of adding air is a syringe.

5. A worm threader comprising:
a pointed threader wherein said threader has a notch for placing a hook; and
a handle having a first end and a second end wherein said first end contains a notch for holding fishing line and said second end is attached to said pointed threader.

6. The worm threader of claim 5 wherein said pointed threader is removably attached to said second end of said handle.

7. The worm threader of claim 5 wherein said pointed threader and said handle float in water.

8. A method for creating a standing worm comprising:
attaching a hook to a fishing line;
wrapping said fishing line around a worm threader containing a notch in the handle;
inserting said worm threader into a worm;
threading said worm on a hook so that the hook is not exposed;
a means of inflating the worm; and
adding a sinker an effective length from the worm.

9. The method for creating a standing worm from claim 8 wherein said means of inflating the worm is adding air.

10. The method for creating a standing worm from claim 8 wherein said means of inflating the worm is a syringe.

11. The method for creating a standing worm from claim 8 wherein said means of adding air is a syringe.
